(19) United States
(12) Patent Application Publication
(10) Pub. No.: US 2018/0100105 A1
(43) Pub. Date: Apr. 12, 2018

(54) ANISOTROPIC SCATTERING FILM

(71) Applicant: DIC Corporation, Tokyo (JP)

(72) Inventors: Hiroshi Hasebe, Saitama (JP); Hidetoshi Nakata, Saitama (JP)

(73) Assignee: DIC Corporation, Tokyo (JP)

(21) Appl. No.: 15/829,578

(22) Filed: Dec. 1, 2017

Related U.S. Application Data
(63) Continuation of application No. PCT/JP2016/065570, filed on May 26, 2016.

(30) Foreign Application Priority Data
Jun. 3, 2015 (JP) 2015-113095

(51) Int. Cl. C09K 19/38; C09K 19/56; G02B 1/02; G02B 5/02

(52) U.S. Cl. CPC C09K 19/3838; C09K 19/56; C09K 2219/03; G02B 5/0257; G02B 5/0268; G02B 1/02

(57) ABSTRACT

An anisotropic scattering film includes a liquid crystal material. The anisotropic scattering film includes a plurality of uniaxial horizontal alignment regions of the liquid crystal material and a plurality of vertical alignment regions of the liquid crystal material.

### TECHNICAL FIELD

One or more embodiments of the present invention relate to an anisotropic scattering film having scattering power which differs according to the light oscillation direction.

### BACKGROUND

It is known that anisotropic scattering bodies having scattering power which differs according to the light oscillation direction can be applied to enhance the brightness of a projection screen (PTL 1) or a liquid crystal display (PTLs 2 and 3). Such anisotropic scattering bodies can be produced by, for example, bringing transparent substances that have an anisotropic shape and a refractive index different from the refractive index of a transparent matrix into a state of being uniformly dispersed in the transparent matrix such that a positional relationship between the transparent substances corresponds to parallel translation in an orderly manner (PTL 1), by dispersing and arranging scattered particles having an aspect ratio of 1 or more into a support medium having a different refractive index (PTL 2), by adopting a uniformly uniaxially aligned structure composed of liquid crystal droplets that are embedded into a polymer matrix, where the droplets are physically stretched along a common axis (PTL 3), by adopting a uniformly uniaxially aligned PDLC structure composed of liquid crystal droplets that are arranged in a common direction by being subjected to an electric field (PTL 3), or by adopting a structure including small-diameter fibers that are arranged and embedded into a matrix (PTL 3). In the above-described known production methods, substances which are not compatible with a support medium are dispersed with directionality (anisotropy) in the support medium. Regarding such a production method, it is necessary that a film be formed while substances which are not compatible with each other are uniformly dispersed. However, the in-plane evenness of the light scattering power of the resulting film may be poor because it is difficult to maintain a uniformly dispersed state.

### CITATION LIST

### Patent Literature

PTL 1: Japanese Unexamined Patent Application Publication No. 4-73637

PTL 2: Japanese Unexamined Patent Application Publication No. 9-274108

PTL 3: Japanese Unexamined Patent Application Publication (Translation of PCT Application) No. 11-502036

### SUMMARY

One or more embodiments of the present invention provide an anisotropic scattering film having excellent in-plane evenness of light scattering power.

As a result of intensive investigations, it was found that an anisotropic scattering film may be produced by using a mutually homogeneously dissolved material system.

One or more embodiments of the present invention provide an anisotropic scattering film including a plurality of uniaxial horizontal alignment regions and a plurality of vertical alignment regions of a liquid crystal material.

The anisotropic scattering film according to one or more embodiments of the present invention is produced by using a mutually homogeneously dissolved material system and, therefore, has good in-plane evenness of light scattering power.

### DETAILED DESCRIPTION OF EMBODIMENTS

An anisotropic scattering film according to one or more embodiments of the present invention includes a plurality of uniaxial horizontal alignment regions and a plurality of vertical alignment regions of a liquid crystal material. At the border between the uniaxial horizontal alignment region and the vertical alignment region, the light that oscillates parallel to the slow axis (major axis direction of a liquid crystal molecule) in the uniaxial horizontal alignment region is scattered due to discordance with the refractive index, and the light that oscillates perpendicularly to the slow axis in the uniaxial horizontal alignment region is not scattered because there is no discordance with the refractive index. The anisotropic scattering film according to one or more embodiments of the present invention functions as an anisotropic scattering film due to such an action.

The most common anisotropic scattering films cause light scattering, to a maximum extent, of polarized light that oscillates in a predetermined direction relative to the entire film surface but cause light scattering, to a minimum extent, of the light that oscillates in the perpendicular direction. Regarding such an anisotropic scattering film, the alignment direction in the plurality of uniaxial horizontal alignment regions may be determined to be an appropriate direction over the entire film surface. In order to ensure light scattering power, the birefringence of the liquid crystal material may be increased or the area of the border between the uniaxial horizontal alignment region and the vertical alignment region may be increased. From such a viewpoint, the size (here, size refers to an average outside diameter) per uniaxial horizontal alignment region and the size (here, size refers to an average outside diameter) per vertical alignment region may be 100 μm or less, 10 μm or less, or 1 μm or less. Further, the ratio of the total area (A) of the plurality of uniaxial horizontal alignment regions to the total area (B) of the plurality of vertical alignment regions may be set to be 3:7 to 7:3, or set to be 4:6 to 6:4.

In one or more embodiments, a polymerizable liquid crystal composition containing a polymerizable liquid crystal compound may be used as the liquid crystal material and the above-described alignment state may be fixed by irradiation with activated energy lines. Ease of handling can be improved by increasing the molecular weight due to irradiation with activated energy lines.

A method for aligning the liquid crystal material so as to include a plurality of uniaxial horizontal alignment regions and a plurality of vertical alignment regions may be a method in which a substrate subjected to aligning treatment is coated with a liquid crystal material and, thereafter, the liquid crystal material spontaneously forms vertical alignment regions and horizontal alignment regions. The aligning treatment includes a method in which a high-molecular-weight thin film of polyimide or the like is formed on a substrate and the high-molecular-weight film is subjected to rubbing treatment, or a method in which direct rubbing is performed when the substrate is a high-molecular-weight film. In order to make the liquid crystal material spontaneously form vertical alignment regions and horizontal alignment regions, a liquid crystal material that exhibits a smectic A phase when being applied may be selected. If the smectic A phase is not selected, vertical alignment regions may be obtained, but hybrid alignment tends to result because no uniaxial horizontal alignment regions are obtained, or uniaxial horizontal alignment regions may be obtained, but hybrid alignment tends to result because no vertical alignment regions are obtained. The reason for this is conjectured to be that the elastic strain energy at a “discontinuous alignment face” present at the border between the vertical alignment region and the uniaxial horizontal alignment region is high and, as a result, a force which changes any one of the region to the hybrid alignment is exerted in order to relax the energy. It is conjectured that, when the smectic A phase is selected, the hybrid alignment does not easily occur because the smectic A phase has a layered structure inside, change to the hybrid alignment is suppressed, and vertical alignment regions and uniaxial horizontal alignment regions are readily present in combination.

The substrate may be a glass base material, a metal base material, a ceramic base material, or an organic material, e.g., a plastic base material. In particular, when the substrate is an organic material, a cellulose derivative, polyolefin, polyester, polyolefin, polycarbonate, polyacrylate, polyallylate, polyether sulfone, polyimide, polyphenylene sulfide, polyphenylene ether, nylon, polystyrene, or the like is used. Above all, a plastic substrate of polyester, polystyrene, polyolefin, a cellulose derivative, polyallylate, polycarbonate, or the like may be used.

Regarding the polymerizable liquid crystal composition that exhibits a smectic A phase, a material having at least two polymerizable functional groups in the molecule may be used. A compound denoted by general formula (I) may be used.

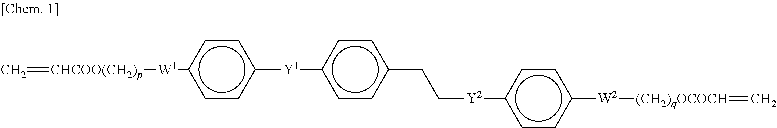

(in the formula, each of W¹ and W² represents a single bond, —O—, —CCO—, or —OCO—, each of Y¹ and Y² represents —COO— or —OCO—, each of p and q represents an integer of 2 to 18, and at least one 1,4-phenylene group present in the formula may be substituted with an alkyl group having a carbon atom number of 1 to 7, an alkoxy group, an alkanoyl group, a cyano group, or a halogen atom)

A compound denoted by general formula (I), in which each of W¹ and W² represents —O—, Y¹ represents —COO—, Y² represents —OCO—, and each of p and q represents an integer of 3 to 12, may be used, and a compound which satisfies p=q=6 or p=q=3 may be used.

Further specifically, the compound denoted by general formula (I) may be any one of the compounds denoted by general formula (I-1) to general formula (I-8).

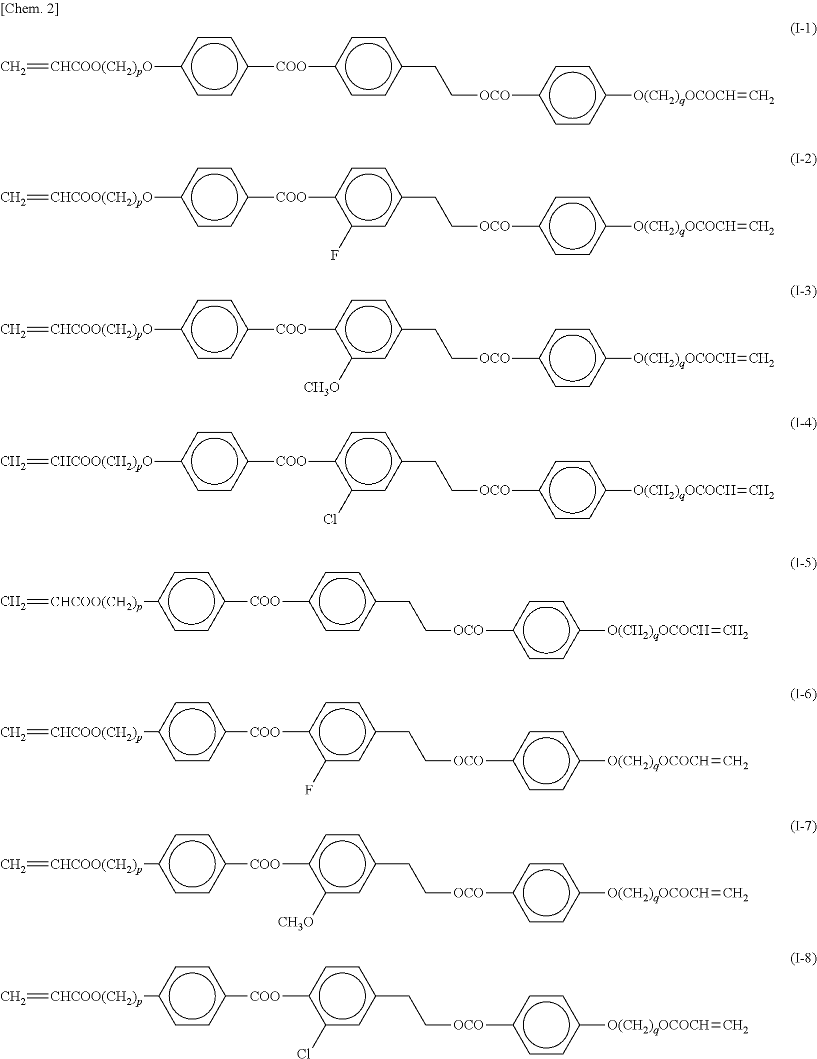

(In the formulae, p and q are the same as those in general formula (I)).

In general formula (I-1) to general formula (I-8), each of p and q may represent an integer of 3 to 12.

For the purpose of realizing a stable liquid crystal phase and for the purpose of avoiding precipitation of a crystalline phase, at least two compounds denoted by general formula (I) may be included, and at least two compounds denoted by general formula (I-1) to general formula (I-8), in which p=q=6 or p=q=3 is satisfied, may be included.

The concentration of the compound denoted by general formula (I) in the polymerizable liquid crystal composition may be 20 percent by mass or more, 40 percent by mass or more, or 60 percent by mass or more from the viewpoint of thermal resistance and liquid crystal temperature range.

In one or more embodiments, the polymerizable liquid crystal composition may contain a compound denoted by general formula (II)

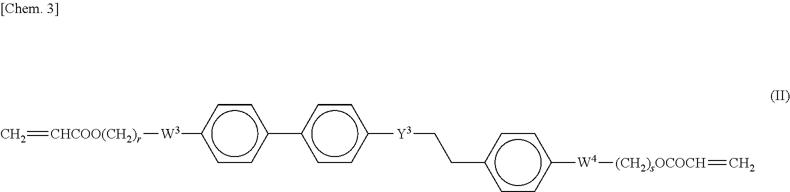

(in the formula, each of W³ and W⁴ represents a single bond, —O—, —COO—, or —OCO—, Y³ represents —COO— or —OCO—, each of r and s represents an integer of 2 to 18, and at least one 1,4-phenylene group present in the formula may be substituted with an alkyl group having a carbon atom number of 1 to 7, an alkoxy group, an alkanoyl group, a cyano group, or a halogen atom). When a bifunctional liquid crystalline acrylate denoted by, for example, general formula (II) is used, a compound that exhibits a smectic A phase at room temperature can easily be obtained. Further specifically, the compound denoted by general formula (II) may be any one of the compounds denoted by general formula (II-1) to general formula (II-10).

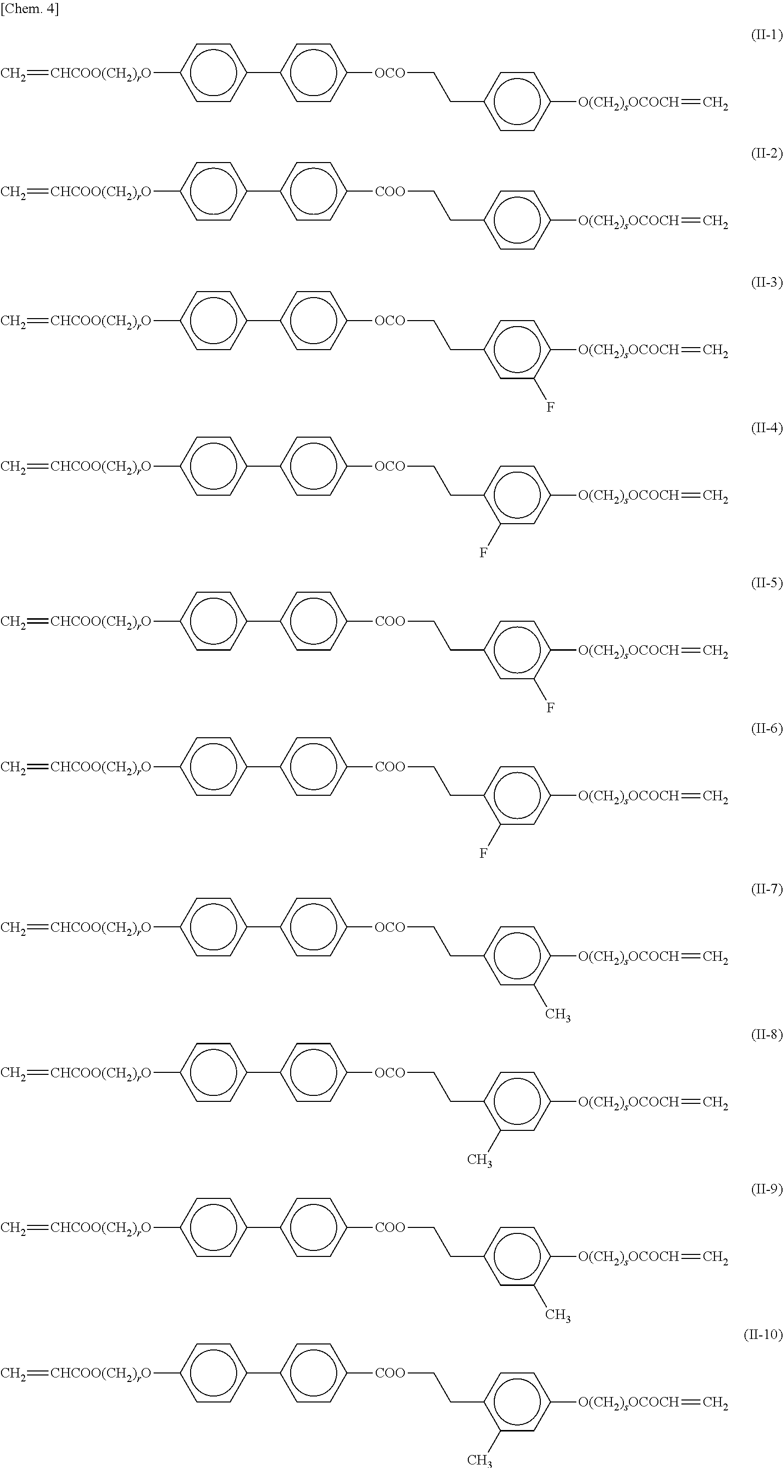

(in the formulae, r and s are the same as those in general formula (II)).

The concentration of the compound denoted by general formula (II) in the polymerizable liquid crystal composition may be 5 to 50 percent by mass, 7 to 40 percent by mass, or 10 to 30 percent by mass from the viewpoint of thermal resistance and liquid crystal temperature range.

In one or more embodiments, the polymerizable liquid crystal composition may contain a monofunctional liquid crystalline acrylate having a cyano group because the smectic A phase tends to be exhibited. Specifically, a compound denoted by general formula (III) may be used.

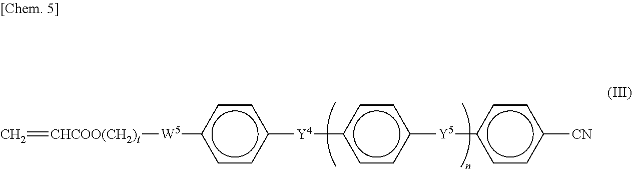

(in the formula, W⁵ represents a single bond, —O—, —COO—, or —OCO—, each of Y⁴ and Y⁵ represents a single bond, —CH₂CH₂COO—, —CH₂CH₂OCO—, —COOCH₂CH₂—, —OCH₂CH₂—, —CH₂CH₂—, —CH₂O—, —OCH₂—, —COO—, —OCO—, —C≡C—, —CH═CH—, —CF═CF—, —(CH₂)₄—, —CH₂CH₂CH₂O—, —OCH₂CH₂CH₂—, —CH═CH—CH₂CH₂—, —CH₂CH₂—CH═CH—, —CH═CH—COO—, or —OCO—CH═CH—, t represents an integer of 2 to 18, n represents 0 or 1, and at least one 1,4-phenylene group present in the formula may be substituted with an alkyl group having a carbon atom number of 1 to 7, an alkoxy group, an alkanoyl group, a cyano group, or a halogen atom) Among the compounds denoted by general formula (III), compounds in which each of Y⁴ and Y⁵ may represent a single bond, —COO—, or —OCO—. Further specifically, compounds denoted by general formula (III-1) to general formula (III-4) may be used.

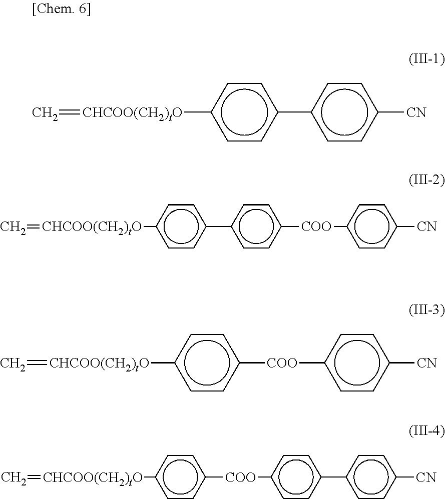

(In the formulae, t is the same as that in general formula (III)).

Among general formula (III-1) to general formula (III-4), the compounds denoted by general formula (III-1) and general formula (III-3) may be used from the viewpoint of setting the lower limit temperature of the smectic A phase to be 40° C. or lower. In one or more embodiments, the compound denoted by general formula (III-1) may be used. In one or more embodiments, t may be 3 to 18, 4 to 16, or 6 to 12. If t is less than 3, realization of the smectic A phase tends to become difficult, and if t is more than 12, the thermal resistance of a polymer produced by photopolymerization tends to be degraded. The concentration of the compound denoted by general formula (III) in the polymerizable liquid crystal composition may be 20 percent by mass or less, or 15 percent by mass or less from the viewpoint of thermal resistance and liquid crystal temperature range.

The polymerizable liquid crystal composition may contain compounds denoted by general formula (a-1) to general formula (a-10), in addition to the above-described compounds, as a bifunctional liquid crystalline acrylate.

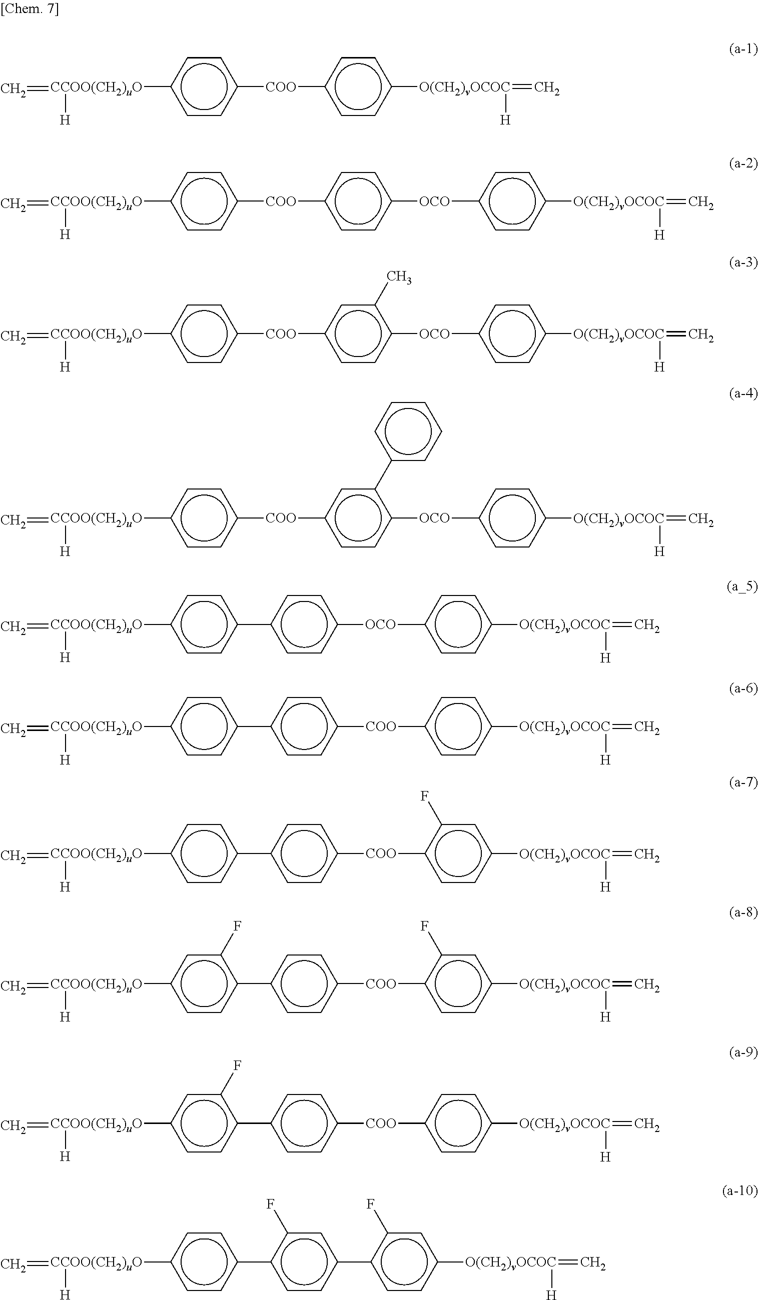

(In the formulae, each of u and v represents an integer of 2 to 18).

In one or more embodiments, each of u and v may be 3 to 18, 4 to 16, or 6 to 12. If each of u and v is less than 3, realization of the smectic A phase tends to become difficult, and if each of u and v is more than 12, the thermal resistance of a polymer produced by photopolymerization tends to be degraded.

A compound having a polymerizable functional group and exhibiting no liquid crystallinity may be added to the polymerizable liquid crystal composition. There is no particular limitation regarding a compound used as such a compound as long as the compound is usually recognized as a polymer-forming monomer or a polymer-forming oligomer in the related art. However, the amount of compound added has to be adjusted such that the resulting composition exhibits a smectic A phase.

The viscosity of the polymerizable liquid crystal composition may be adjusted to 2,000 mPa·s or more, 3,500 cps or more, or 5,000 mPa·s or more at room temperature (25° C.) for the purpose of ensuring coating properties.

In addition, a photopolymerization initiator may be added to the polymerizable liquid crystal composition for the purpose of improving polymerization reactivity.

Examples of photopolymerization initiators include benzoin ethers, benzophenones, acetophenones, benzyl ketals, and acylphosphine oxides. The amount of addition thereof may be within the range of 0.01 to 5 percent by mass, 0.02 to 1 percent by mass, or 0.03 to 1 percent by mass, relative to the liquid crystal composition.

Also, a stabilizer may be added to the polymerizable liquid crystal composition for the purpose of improving preservation stability thereof. Examples of usable stabilizers include hydroquinone, hydroquinone monoalkyl ethers, tert-butylcatechol and the like, pyrogallol and the like, thiophenols, nitro compounds, β-naphthylamines, β-naphthol and the like, and nitroso compounds. When the stabilizer is used, the amount of the stabilizer added may be within the range of 0.005 to 1 percent by mass, 0.02 to 0.5 percent by mass, or 0.03 to 0.1 percent by mass, relative to the liquid crystal composition.

Regarding additives to the polymerizable liquid crystal composition, selection and the concentration of an additive that facilitates horizontal alignment are important. A material that exhibits a smectic A phase has a strong tendency toward vertical alignment. Therefore, if an additive that facilitates horizontal alignment is not added, even when the substrate is coated with the polymerizable liquid crystal composition, vertical alignment occurs over the entire surface, and there is a tendency that a region in which uniaxial horizontal alignment occurs is not easily realized. Then, it may be possible to realize a region, in which uniaxial horizontal alignment occurs, by adding an additive that facilitates horizontal alignment of the liquid crystal material. Such an additive may be a compound including a repeating unit denoted by general formula (IV)

[Chem. 8]

CR¹R²—CR³R⁴ (IV)

(in the formula, each of R¹, R², R³, and R⁴ represents a hydrogen atom, a halogen atom, or a hydrocarbon group having a carbon atom number of 1 to 20, and at least one hydrogen atom in the hydrocarbon group may be substituted with a halogen atom). Examples of compounds denoted by general formula (IV) include polyethylenes, polypropylenes, polyisobutylenes, paraffins, liquid paraffins, chlorinated polypropylenes, chlorinated paraffins, and chlorinated liquid paraffins. The concentration of such a compound in the polymerizable liquid crystal composition may be adjusted to 0.001 to 0.05 percent by weight, 0.002 to 0.04 percent by weight, or 0.003 to 0.03 percent by weight. If the amount of addition is small, the total area of uniaxial horizontal alignment regions tends to decrease, and if the amount of addition is large, the total area of horizontal alignment regions tends to increase.

In one or more embodiments, in addition to the above-described adjustment of the additive concentration, alignment treatment of the coated substrate is also important from the viewpoint of area control of the uniaxial horizontal alignment regions and the vertical alignment regions. Typical alignment treatment is rubbing. When so-called “rubbing strength” is increased (for example, the rubbing strength is increased as the pressure of pressing a rubbing cloth against a substrate is increased or as the rotational speed of a rubbing roller is increased), a total area of uniaxial horizontal alignment regions tends to increase. Therefore, the above-described adjustment of the additive concentration has to be performed in consideration of the rubbing strength.

In one or more embodiments, a surfactant may be added to the polymerizable liquid crystal composition for the purpose of ensuring the leveling properties of the coating film. Examples of surfactants that may be contained in the polymerizable liquid crystal composition include alkyl carboxylates, alkyl phosphates, alkyl sulfonates, fluoroalkyl carboxylates, fluoroalkyl phosphates, fluoroalkyl sulfonates, polyoxyethylene derivatives, fluoroalkylethylene oxide derivatives, polyethylene glycol derivatives, alkylammonium salts, fluoroalkylammonium salts, and silicone derivatives. In one or more embodiments, fluorine-containing surfactants and silicone derivatives may be used. Further specific examples include “MEGAFAC F-110”, “MEGAFAC F-113”, “MEGAFAC F-120”, “MEGAFAC F-812”, “MEGAFAC F-142D”, “MEGAFAC F-144D”, “MEGAFAC F-150”, “MEGAFAC F-171”, “MEGAFAC F-173”, “MEGAFAC F-177”, “MEGAFAC F-183”, “MEGAFAC F-195”, “MEGAFAC F-824”, “MEGAFAC F-833”, “MEGAFAC F-114”, “MEGAFAC F-410”, “MEGAFAC F-493”, “MEGAFAC F-494”, “MEGAFAC F-443”, “MEGAFAC F-444”, “MEGAFAC F-445”, “MEGAFAC F-446”, “MEGAFAC F-470”, “MEGAFAC F-471”, “MEGAFAC F-474”, “MEGAFAC F-475”, “MEGAFAC F-477”, “MEGAFAC F-478”, “MEGAFAC F-479”, “MEGAFAC F-480SF”, “MEGAFAC F-482”, “MEGAFAC F-483”, “MEGAFAC F-484”, “MEGAFAC F-486”, “MEGAFAC F-487”, “MEGAFAC F-489”, “MEGAFAC F-172D”, “MEGAFAC F-178K”, “MEGAFAC F-178RM”, “MEGAFAC R-08”, “MEGAFAC R-30”, “MEGAFAC F-472SF”, “MEGAFAC BL-20”, “MEGAFAC R-61”, “MEGAFAC R-90”, “MEGAFAC ESM-1”, and “MEGAFAC MCF-350SF” (these are produced by DIC Corporation), “Ftergent 100”, “Ftergent 100C”, “Ftergent 110”, “Ftergent 150”, “Ftergent 150CH”, “Ftergent A”, “Ftergent 100A-K”, “Ftergent 501”, “Ftergent 300”, “Ftergent 310”, “Ftergent 320”, “Ftergent 400SW”, “FTX-400P”, “Ftergent 251”, “Ftergent 215M”, “Ftergent 212MH”, “Ftergent 250”, “Ftergent 222F”, “Ftergent 212D”, “FTX-218”, “FTX-209F”, “FTX-213F”, “FTX-233F”, “Ftergent 245F”, “FTX-208G”, “FTX-240G”, “FTX-206D”, “FTX-220D”, “FTX-230D”, “FTX-240D”, “FTX-207S”, “FTX-211S”, “FTX-220S”, “FTX-230S”, “FTX-750FM”, “FTX-730FM”, “FTX-730FL”, “FTX-710FS”, “FTX-710FM”, “FTX-710FL”, “FIX-750LL”, “FTX-730LS”, “FTX-730LM”, “FTX-730LL”, and “FIX-71OLL” (these are produced by NEOS COMPANY LIMITED), “BYK-300”, “BYK-302”, “BYK-306”, “BYK-307”, “BYK-310”, “BYK-315”, “BYK-320”, “BYK-322”, “BYK-323”, “BYK-325”, “BYK-330”, “BYK-331”, “BYK-333”, “BYK-337”, “BYK-340”, “BYK-344”, “BYK-370”, “BYK-375”, “BYK-377”, “BYK-350”, “BYK-352”, “BYK-354”, “BYK-355”, “BYK-356”, “BYK-358N”, “BYK-361N”, “BYK-357”, “BYK-390”, “BYK-392”, “BYK-UV3500”, “BYK-UV3510”, “BYK-UV3570”, and “BYK-Silclean3700” (these are produced by BYK Japan KK), and “TEGO Rad 2100”, “TEGO Rad 2200N”, “TEGO Rad 2250”, “TEGO Rad 2300”, “TEGO Rad 2500”, “TEGO Rad 2600”, and “TEGO Rad 2700” (these are produced by TEGO). An amount of the surfactant added may differ according to the components other than the surfactant included in the polymerizable liquid crystal composition, the temperature during use, and the like. The content in the polymerizable liquid crystal composition may be 0.01 to 1 percent by mass, 0.02 to 0.5 percent by mass, or 0.03 to 0.1 percent by mass. If the content is less than 0.01 percent by mass, an effect of reducing variations in the film thickness may not be easily exerted.

Regarding a method for coating the substrate with the polymerizable liquid crystal composition, commonly known methods, e.g., an applicator method, a bar coating method, a spin coating method, a gravure printing method, a flexo printing method, an ink jet method, a die coating method, a cap coating method, and a dipping method, may be performed. A polymerizable liquid crystal composition diluted with a solvent may be applied. A solvent that does not dissolve the substrate or an alignment film disposed on the substrate when being applied to the substrate is used. In this regard, the solvent may be used to dissolve the polymerizable liquid crystal composition smoothly. Examples of usable solvents include aromatic hydrocarbon, e.g., toluene, xylene, cumene, and mesitylene, ester-based solvents, e.g., methyl acetate, ethyl acetate, propyl acetate, and butyl acetate, ketone-based solvents, e.g., methyl ethyl ketone, methyl isobutyl ketone, and cyclohexanone, ether-based solvents, e.g., tetrahydrofuran, 1,2-dimethoxyethane, and anisole, amide-based solvents, e.g., N,N-dimethylformamide and N-methyl-2-pyrrolidone, propylene glycol monomethyl ether acetate, diethylene glycol monomethyl ether acetate, y-butyrolactone, and chlorobenzene. These may be used alone, or at least two types may be used in combination.

There is no particular limitation regarding the proportion of the solvent within the bounds of not significantly impairing the coating state because the polymerizable liquid crystal composition is usually applied by coating. The ratio of the solid content to the solvent in the polymerizable liquid crystal composition may be 0.1:99.9 to 80:20, and 1:99 to 60:4 may be used in consideration of coating properties.

When the solvent is used, the solvent may be vaporized by being heated at 60° C. to 100° C., or 80° C. to 90° C. The heating time may be 5 seconds to 3 minutes.

Regarding polymerizing operation of the polymerizable liquid crystal composition, the solvent in the polymerizable liquid crystal composition may be removed by drying or the like and, thereafter, in general, irradiation with activated energy lines be performed in a predetermined alignment state. Ultraviolet rays or electron beams may be used as the activated energy lines. From the viewpoint of simplicity of an apparatus, ultraviolet rays may be used as the activated energy lines. When the polymerization is performed by ultraviolet ray irradiation, ultraviolet rays of 390 nm or less may be applied, and light with a wavelength of 250 to 370 nm may also be applied. However, when decomposition and the like of the polymerizable liquid crystal composition are caused by ultraviolet rays of 390 nm or less, in some cases, the polymerization treatment may be performed with ultraviolet rays of 390 nm or more. The light may be diffused and unpolarized light. The intensity of the ultraviolet rays may be 1 to 100 mW/cm², 2 to 50 mW/cm², or 5 to 30 mW/cm². The irradiation energy may be 5 to 200 mJ/cm², 10 to 150 mJ/cm², or 20 to 120 mJ/cm².

### EXAMPLES

Polymerizable liquid crystal composition (A) having a composition described below was prepared.

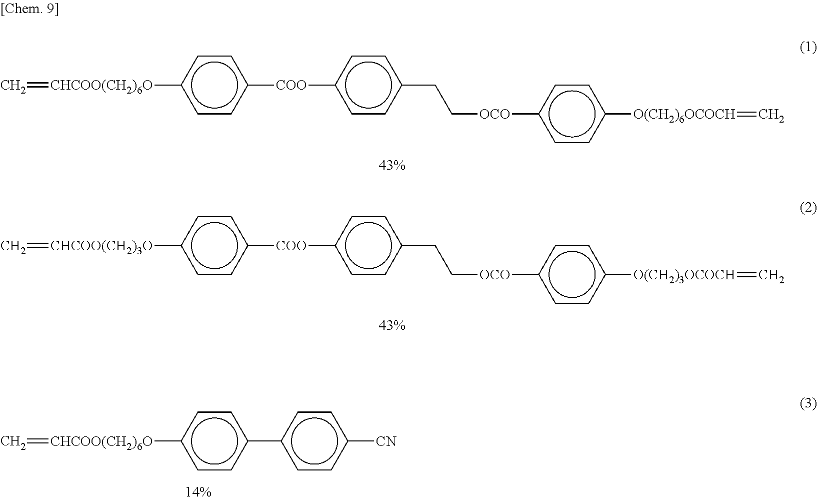

When polymerizable liquid crystal composition (A) was once heated to an isotropic liquid phase and then was cooled, phase transition to a nematic phase occurred at 70° C., and phase transition to a smectic A phase occurred at 35° C. The smectic A phase was maintained even at room temperature. Component (A-1) was prepared by adding 3% of photopolymerization initiator Irgacure 907 (produced by Ciba Specialty Chemicals) and 0.01% of polypropylene serving as a horizontal alignment additive and having a mass average molecular weight of 1,650 to polymerizable liquid crystal composition (A). Further, coating composition (A-2) was prepared by dissolving composition (A-1) into propylene glycol monomethyl ether acetate such that the concentration became 30%.

Next, a TAC film (thickness of 50 μm) having a width of 15 cm and a length of 15 cm was prepared, and rubbing treatment was performed in the direction parallel to the length direction. Composition (A-2) was dropped onto the substrate subjected to the rubbing treatment, and the entire surface was coated by using a #5 wire bar. This was dried at 80° C. for 3 minutes and was maintained at room temperature for 3 minutes. Thereafter, UV light was applied at an intensity of 15 mW/cm² for 10 seconds so as to increase the molecular weight of the polymerizable liquid crystal composition and to produce a film. The thickness measured 1.1 μm. The resulting film was combined with a polarization film and examination was performed. As a result, it was ascertained that the polarized light which oscillated in the direction parallel to the rubbing direction was scattered, the polarized light which oscillated in the vertical direction was passed through without being scattered, and a function as an anisotropic scattering plate was performed. According to visual observation, the in-plane light scattering power of the film was even, and there was no variation. The haze was measured at four corners and the center of the film. As a result, hazes fell within the range of 44%±1% and, therefore, it was quantitatively ascertained that evenness was excellent.

Although the disclosure has been described with respect to only a limited number of embodiments, those skilled in the art, having benefit of this disclosure, will appreciate that various other embodiments may be devised without departing from the scope of the present invention. Accordingly, the scope of the present invention should be limited only by the attached claims.

What is claimed is:

1. An anisotropic scattering film comprising a liquid crystal material, wherein
the anisotropic scattering film comprises a plurality of uniaxial horizontal alignment regions of the liquid crystal material and a plurality of vertical alignment regions of the liquid crystal material.

2. The anisotropic scattering film according to claim 1, wherein an alignment direction in the plurality of uniaxial horizontal alignment regions is a predetermined direction.

3. The anisotropic scattering film according to claim 1, wherein an average size of the uniaxial horizontal alignment region and an average size of the vertical alignment region are each 100 μm or less.

4. The anisotropic scattering film according to claim 1, wherein the ratio of a total area of the plurality of uniaxial horizontal alignment regions to a total area of the plurality of vertical alignment regions is 3:7 to 7:3.

5. The anisotropic scattering film according to claim 1, wherein the liquid crystal material is a polymerizable liquid crystal composition, and an alignment state of the liquid crystal material is fixed by irradiation with active energy rays.

6. The anisotropic scattering film according to claim 1, wherein the liquid crystal material is in a state of a smectic A phase.

7. The anisotropic scattering film according to claim 1, wherein the liquid crystal material is a polymerizable liquid crystal composition comprising a compound denoted by general formula (I) 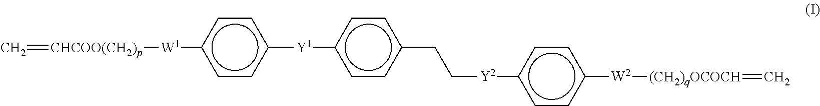
(in the general formula (I), W¹ and W² each independently represents a single bond, —O—, —COO—, or —OCO—; Y¹ and Y² each independently represents —COO— or —OCO—; and p and q each independently represents an integer of 2 to 18).

8. The anisotropic scattering film according to claim 7, wherein at least one 1,4-phenylene group present in the general formula (I) is substituted with an alkyl group having a carbon atom number of 1 to 7, an alkoxy group, an alkanoyl group, a cyano group, or a halogen atom.

9. A method for manufacturing an optically anisotropic body, the method comprising:
preparing a polymerizable liquid crystal composition; and
applying the polymerizable liquid crystal composition to a surface of a substrate,
wherein the polymerizable liquid crystal composition comprises a compound denoted by general formula (II) 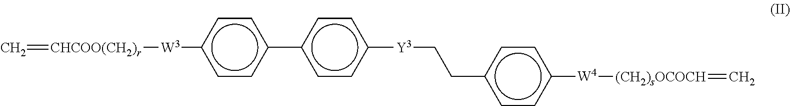
(in the general formula (II), W³ and W⁴ each independently represents a single bond, —O—, —COO—, or —OCO—; Y³ represents —COO— or —OCO—; and r and s each independently represents an integer of 2 to 18), and
wherein the optically anisotropic body comprises a plurality of uniaxial horizontal alignment regions of the polymerizable liquid crystal composition and a plurality of vertical alignment regions of the polymerizable liquid crystal composition.

10. The method according to claim 9, wherein at least one 1,4-phenylene group present in the general formula (II) is substituted with an alkyl group having a carbon atom number of 1 to 7, an alkoxy group, an alkanoyl group, a cyano group, or a halogen atom.

11. The anisotropic scattering film according to claim 1, wherein the liquid crystal material is a polymerizable liquid crystal composition comprising a compound denoted by general formula (III) 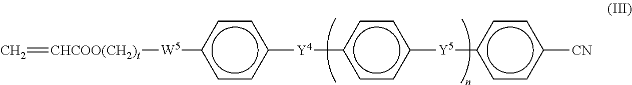
(in the general formula (III), W⁵ represents a single bond, —O—, —COO—, or —OCO—; Y⁴ and Y⁵ each independently represents a single bond, —CH₂CH₂COO—, —CH₂CH₂OCO—, —COOCH₂CH₂—, —OCOCH₂CH₂—, CH₂CH₂—, —CH₂O—, —OCH₂—, —COO—, —OCO—, —C≡C—, —CH═CH—, —CF═CF—, —(CH₂)₄—, —CH₂CH₂CH₂O—, —OCH₂CH₂CH₂—, —CH═CH—CH₂CH₂—, —CH₂CH₂—CH═CH—, —CH═CH—COO—, or —OCO—CH═CH—; t represents an integer of 2 to 18; and n represents 0 or 1).

12. The anisotropic scattering film according to claim 11, wherein at least one 1,4-phenylene group present in the general formula (III) is substituted with an alkyl group having a carbon atom number of 1 to 7, an alkoxy group, an alkanoyl group, a cyano group, or a halogen atom.
